(19) United States
(12) Patent Application Publication
(10) Pub. No.: US 2012/0311867 A1
(43) Pub. Date: Dec. 13, 2012

(54) ADJUSTABLE SEAL TRIMMER AND METHOD OF USE THEREOF

(75) Inventors: Ian J. Baker, Baldwinsville, NY (US); Noah Montena, Syracuse, NY (US); Christopher P. Natoli, Fulton, NY (US); Adam T. Nugent, Canastota, NY (US)

(73) Assignee: JOHN MEZZALINGUA ASSOCIATES, INC., East Syracuse, NY (US)

(21) Appl. No.: 13/157,368

(22) Filed: Jun. 10, 2011

(51) Int. Cl. B26D 3/16; B26D 7/27

(52) U.S. Cl. 30/92; 83/13

(57) ABSTRACT

A support member having an inner sleeve portion and an outer sleeve portion defining a cavity therebetween, and a length guide portion variably disposed within the cavity of the support member is provided. Moreover, an inner sleeve portion insertable within the port seal for preventing deformation of the seal under a force of a cutting blade, an outer sleeve portion configured to radially surround a port seal, a bottom surface portion connecting the outer sleeve portion to the inner sleeve portion, wherein the bottom surface portion includes a plurality of openings, a plurality of axial fingers configured to extend from the bottom surface portion through the plurality of openings, wherein an extension of the plurality of axial fingers determines a length of a port seal is also provided. Furthermore, an associated method is also provided.

### FIELD OF TECHNOLOGY

The following relates to a seal trimmer, and more specifically to embodiments of an adjustable seal trimmer for a cutting a port seal to various sizes.

### BACKGROUND

Moisture migration is a problem for coaxial cable ports, especially those regularly exposed to environmental pollutants. To prevent moisture migration, a port can be sealed with a piece of rubber commonly referred to as a port seal. Because ports have various lengths and sizes, the port seal must be trimmed to fit the existing port. Presently, trimming the port seal to length requires installers to use a great degree of care to both cut the rubber port seal evenly without leaving jagged mismatches on the cut surface of the port seal, as well as estimating the needed length of the port seal. For example, the rubber port seal may deform or squash as the installer's blade attempt's to slice through the rubber seal, causing random notches and an overall discontinuous cut surface of the port seal. A port seal that does not have an even cut around its body or a port seal which is shorter than the needed length to cover the port may perform undesirably, including an inability to prevent moisture migration and ingress of other environmental pollutants.

Thus, a need exists for an apparatus and method for evenly trimming a port seal to its correct length.

### SUMMARY

A first general aspect relates to a seal trimmer comprising a support member having an inner sleeve portion and an outer sleeve portion defining a cavity therebetween, and a length guide portion variably disposed within the cavity of the support member.

A second general aspect relates to an apparatus comprising an inner sleeve portion insertable within the port seal for preventing deformation of the seal under a force of a cutting blade, an outer sleeve portion configured to radially surround a port seal, a bottom surface portion connecting the outer sleeve portion to the inner sleeve portion, wherein the bottom surface portion includes a plurality of openings, and a plurality of axial fingers configured to extend from the bottom surface portion through the plurality of openings, wherein an extension of the plurality of axial fingers determines a length of a port seal.

A third general aspect relates to an annular member having an inner sleeve portion and an outer sleeve portion defining a cavity therebetween, and a means for determining a desired length of a port seal.

A fourth general aspect relates to a method of determining a desired length of a port seal, comprising providing an annular member having an inner sleeve portion and an outer sleeve portion defining a cavity therebetween; and a length guide portion variably disposed within the cavity of the annular member, advancing the length guide portion towards a base portion of a port to vacate a portion of the cavity, and inserting the port seal into the vacated cavity of the support member.

A fifth general aspect relates to a method of determining a desired length of a port seal, comprising providing a support member having an inner sleeve portion and an outer sleeve portion defining a cavity therebetween; and a length guide portion variably disposed within the cavity of the support member, inserting the seal into a second end of the support member to axially displace the length guide portion from the cavity, and trimming an exposed portion of the seal beyond the second end of the support member.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts an schematic perspective view of an embodiment of a seal trimmer, a port, and a port seal prior to placement on the port;

FIG. 1B depicts a perspective view of an embodiment of the seal trimmer being used to determine a length of the port seal;

FIG. 2 depicts a cross-section view of an embodiment of a support member FIG. 3 depicts a perspective view of an embodiment of the support member;

FIG. 4 depicts an end view of an embodiment of the second end of the support member;

FIG. 5 depicts an end view of an embodiment of the first end of the support member;

FIG. 6 depicts a perspective view of an embodiment of a length guide portion;

FIG. 7A depicts a cross-section view of an embodiment of the seal trimmer in a closed position;

FIG. 7B depicts a perspective view of an embodiment of the seal trimmer in a closed position;

FIG. 8 depicts a cross-section view of an embodiment of the seal trimmer in an extended position;

FIG. 9 depicts a cross-section view of an embodiment of the seal trimmer prior to an insertion of the port seal, in the closed position;

FIG. 10 depicts a cross-section view of an embodiment of the seal trimmer after the port seal has been partially inserted into the support member;

FIG. 11 depicts a cross-section view of an embodiment of the seal trimmer in an extended position; and

FIG. 12 depicts a perspective view of an embodiment of a seal trimmer having an integral cutting means proximate.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

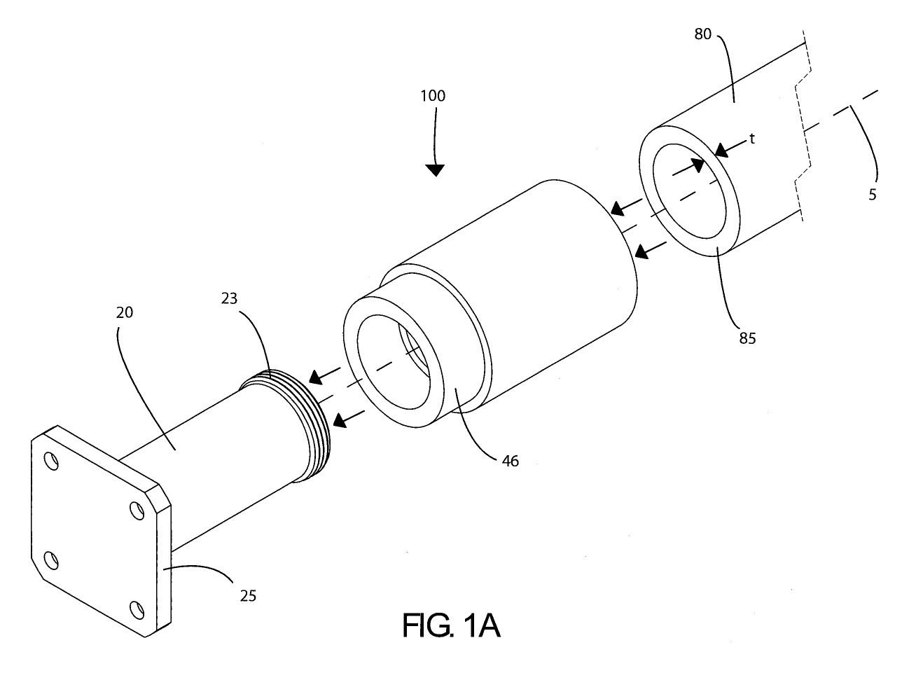

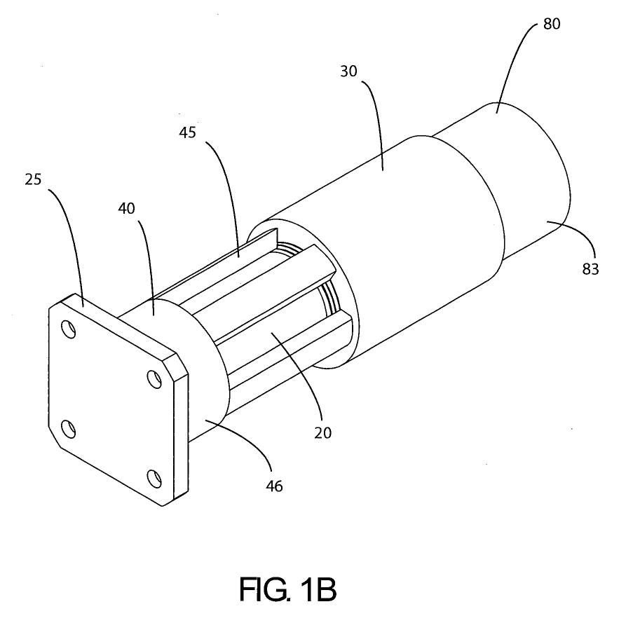

Referring to the drawings, FIGS. 1A and 1B, embodiments of a seal trimmer 100 may include a support member 30 and a length guide portion 40 operably attached to the support member 30. Embodiments of the seal trimmer 100 may also include a support member 30 having an inner sleeve portion 36 and an outer sleeve portion 38 defining a cavity 37 therebetween, and a length guide portion 40 variably disposed within the cavity 37 of the support member 30. Further embodiments of seal trimmer 100 may include an inner sleeve portion 36 insertable within a port seal 80 for preventing deformation of the port seal 80 under a force of a cutting blade, an outer sleeve portion 38 configured to radially surround the port seal 80, a bottom surface portion 39 connecting the outer sleeve portion 38 to the inner sleeve portion 36, wherein the bottom surface portion 39 includes a plurality of openings 35, and a plurality of axial fingers 45 configured to extend from the bottom surface portion 39 through the plurality of openings 35, wherein an extension of the plurality of axial fingers 45 determines a length of a port seal 80. Moreover, seal trimmer 100 may be used to trim the lengths of a seal, such as a port seal, for placement over a port, such as port 20. For instance, the length, or depth, of a seal, such as seal 80, may need to be cut to match the size of an existing port 20. Furthermore, seal trimmer 100 may prevent the occurrence of irregularities on a cut surface of the seal 80 that may occur when the seal 80 deforms under the force of an installer's knife. Irregularities of a cut surface, or mating edge 85 of the seal 80, may include jagged edges, notches, serrations, or any surface irregularity that may lead to a discontinuous or uneven mating edge 85. The seal trimmer 100 may be provided to an installer in a preassembled configuration or may be assembled as needed to allow for interchangeability of components (e.g. installer may assemble and disassemble a seal trimmer 100 having a support member 30 and a length guide portion 40 having a first size, and swap it out with a length guide portion 40 having a second size).

Embodiments of a seal 80 may be a generally annular tubular member configured to radially surround, or be disposed over, port 20 to provide a seal for environmental elements, such as moisture, contaminants, rainwater, dirt, corrosive elements, and/or other elements which may have deleterious effects on a port 20. Seal 80 may be comprised of an elastomeric material such as rubber, silicone rubber, and the like, having elastomer polymeric characteristics.

Referring still to FIGS. 1A and 1B, embodiments of a port 20 may be a conductive receptacle for receiving a portion of a coaxial cable center conductor (not shown) sufficient to make adequate electrical contact, wherein the port includes a base portion 25 that may be mounted to a structure or other suitable substratum. The port 20 may further comprise a threaded exterior surface 23 to threadably engage a coupling member of a connector, such as coaxial cable connector. The port 20 may be exposed to environmental conditions, such as being located on a cell tower or cell site. Moreover, the radial thickness and/or the length of the port 20 and/or the conductive receptacle of the port 20 may vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials. However, the receptacle of the port 20 should be formed of a conductive material, such as a metal, like brass, copper, or aluminum. Further still, it will be understood by those of ordinary skill that the port 20 may be embodied by a connective interface component of a coaxial cable communications device, or other communications modifying devices such as a signal splitter, a cable line extender, a cable network module and/or the like.

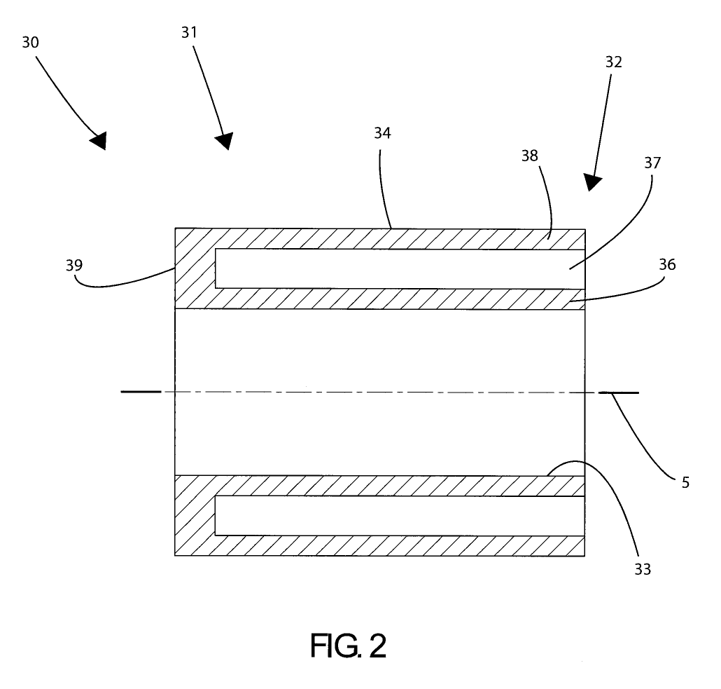

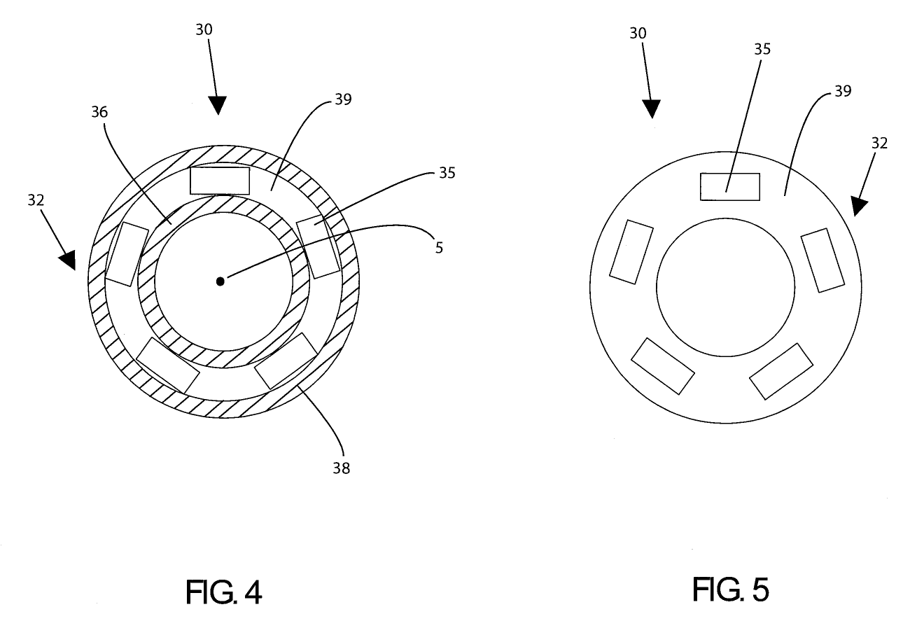

With reference now to FIGS. 2-5, embodiments of a seal trimmer 100 may include a seal support member 30. The support member 30 may accommodate, receive, accept, etc., a seal 80, and may structurally support or prevent the inward deformation of the seal 80 when the seal 80 is being trimmed. In other words, a seal 80 may be insertable within the support member 80 to displace a guide portion 40, described in greater detail supra. The support member 30 may include a first end 31, a second end 32, an inner surface 33, an outer surface 34, and a bottom surface portion 39. The support member 30 may be an annular member having a generally axial opening therethrough. Furthermore, the support member 30 may also include a first portion 36 and a second portion 38. The inner sleeve portion 36 and the outer sleeve portion 36 may be a sleeve, or similar cylindrical shaped portion; however, the inner and outer sleeve portions 36, 38 need not be a continuous cylinder to function properly. Accordingly, embodiments of a seal trimmer 100 may include a first portion 36 and a second portion 38.

Embodiments of an inner sleeve portion 36 and an outer sleeve portion 38 can be structurally integral with a common bottom surface 39 of the support member 30. However, the inner sleeve portion 36 and the outer sleeve portion 38 may be separated by a distance, defining cavity 37. The distance separating the inner sleeve portion 36 and the outer sleeve portion 38 defining cavity 37 should be at least enough to accommodate a thickness, t, of the seal 80. For example, the radial distance between an inner surface of the outer sleeve portion 38 and the outer surface of the inner sleeve portion 36 may be large enough to accommodate the thickness, t, of the seal 80 as well as permit axial movement of the seal 80 between the outer sleeve portion 38 and the inner sleeve portion 36 in a direction towards and away from the first end 31 of the support member 30. In other words, the inner sleeve portion 36 and the outer sleeve portion 38 may share a concentric and/or radial relationship with respect to a central axis 5 of the seal trimmer 100. Specifically, the outer sleeve portion 38 can be a greater radial distance away from the central axis 5 of the seal trimmer 100 than the inner sleeve portion 38. The difference between the radial distances from the central axis 5 of the seal trimmer 100 of the inner and outer sleeve portions 36, 38 may define cavity 37. The cavity 37 (and the distances between the central axis 5) may vary according to the various types and thicknesses of seal 80. Cavity 37 may be an annular opening, void, space, slot, and the like.

Embodiments of the inner sleeve portion 36 of the support member 30 may be configured to be inserted within the axial opening of the seal 80 (e.g. insertable within an inner diameter of the seal 80). For instance, the seal 80 may be disposed over the inner sleeve portion 36 but within the outer sleeve portion 38 and slid further towards the first end 31 of the support member 30. Once the seal 80 is slid into the support member 30 the requisite distance, an exposed portion 83 of the seal 80 may be cut off to trim the seal 80. The inner sleeve portion 36, due to its rigid characteristics, may prevent the seal 80 from squashing or otherwise deforming under the cutting force of an installer's blade because the seal 80 is disposed over the inner sleeve portion 36. Moreover, the inner sleeve portion 36 may act as a structural cutting edge for ensuring an even, continuous cut completely around the seal 80. Thus, the support provided by the inner sleeve portion 36 to the seal 80 when trimming the exposed portion 83 may reduce or eliminate the likelihood of notches, serrations, or other surface irregularities that may lead to a discontinuous cut surface, or mating edge 85.

Embodiments of the outer sleeve portion 38 of the support member 30 may be configured to surround a portion of the inserted seal 80. For instance, the seal 80 may be inserted into cavity 37 a requisite distance leaving the outer sleeve portion 38 visible to the installer. Because the outer sleeve portion 38 extends the same or substantially the same axial distance from the bottom surface portion 39 as the inner sleeve portion 36, the installer may utilize the edge of the outer sleeve portion 38 proximate the second end 32 of the support member 30 as a trimming guide. In other words, the outer sleeve portion 38 surrounding the seal 80 may indicate to the installer the proximity of the inner sleeve portion 36 so the cutting blade may be properly placed close to an end or edge of the inner sleeve portion 36 without seeing the inner sleeve portion 36. Accordingly, the installer may simply align a cutting blade with the edge of the outer sleeve portion 38 at the second end 32, while the inner sleeve portion 36 provides support (i.e. prevents deformation of the seal 80) to the seal 80 during the slicing of the seal 80.

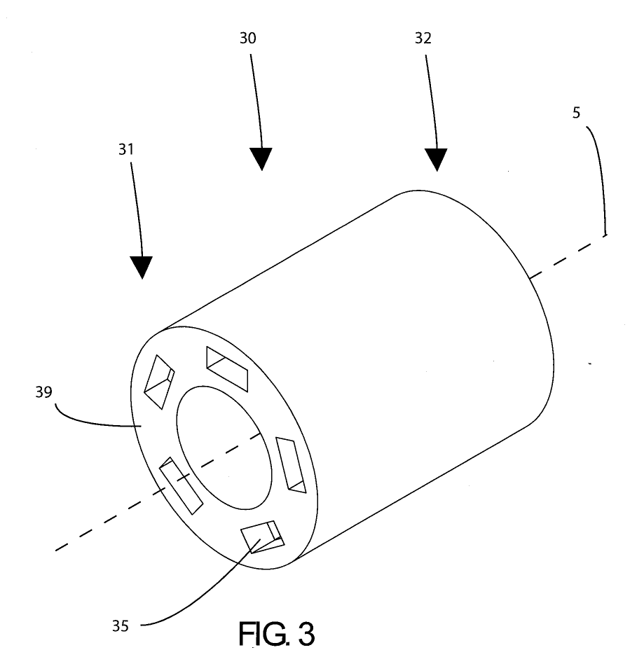

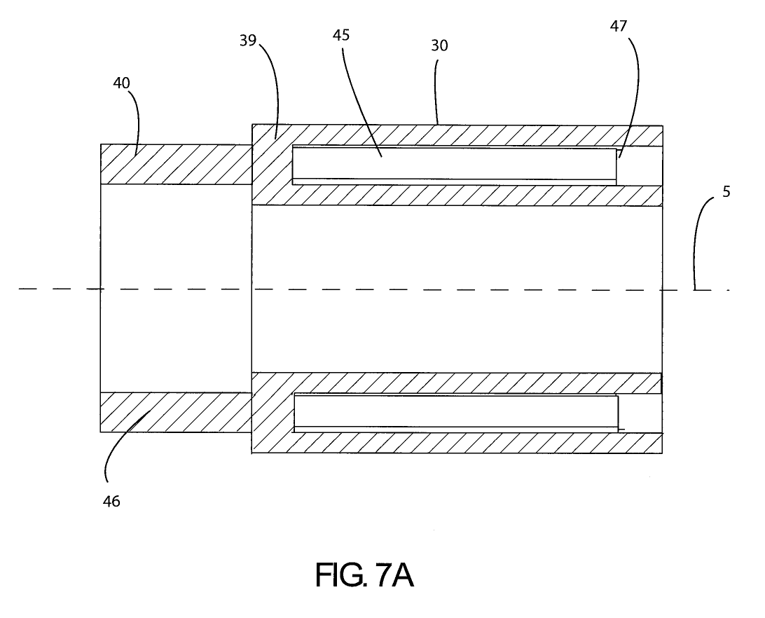

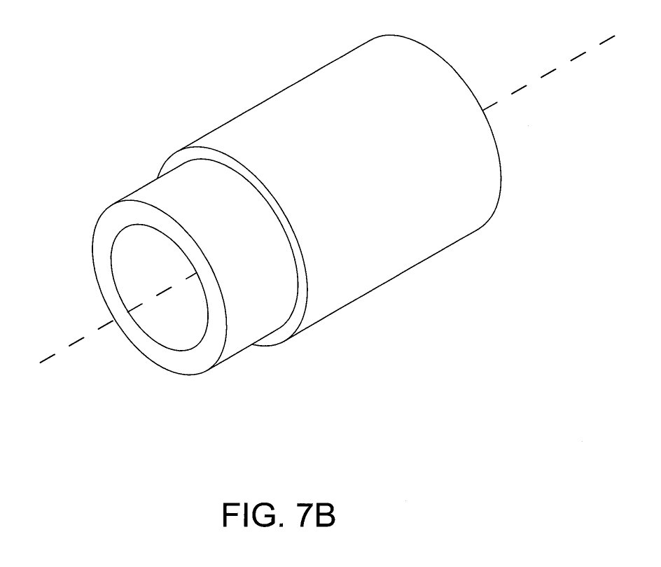

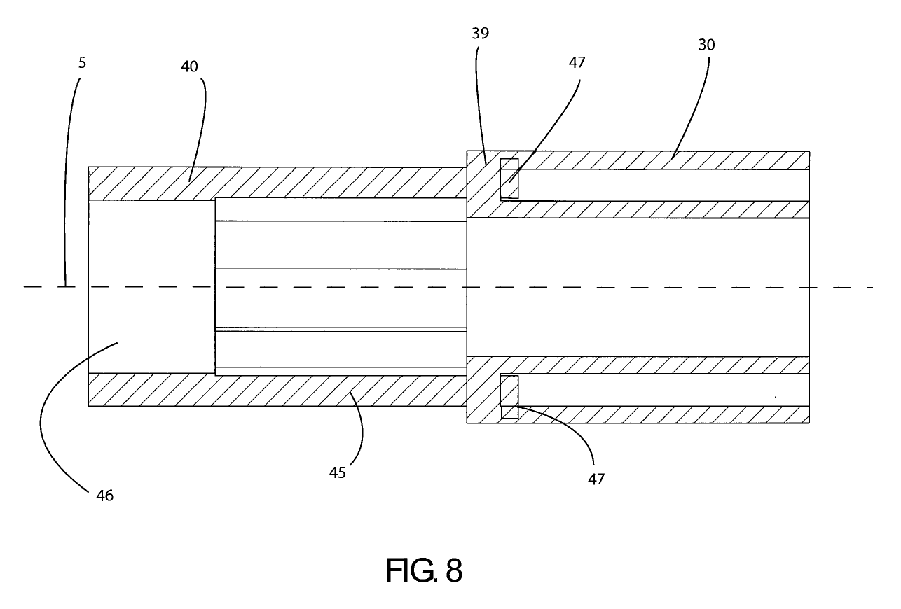

With particular reference to FIGS. 3 and 4, embodiments of the support member 30 may include one or more openings 35 on the bottom surface portion 39 proximate the first end 31 of the support member 30. The opening(s) 35 may be slots, circular holes, punch holes, rectangular or square openings, keyways, C-shaped openings, and the like, that may extend through the thickness of the bottom surface portion 39 of the support member 30. The opening(s) 35 may provide access from external to the support member 30 to the cavity 37 located between the inner and outer sleeve portion 36, 38. In most embodiments, the openings 35 may be sized and dimensioned to provide clearance to allow fingers 45 of the length guide portion 40 to be removably inserted into the cavity 37 of the support member 30. For example, in a first, closed position, the fingers 45, or a portion of the fingers 45, of the length guide portion 40 may reside within the cavity 37, passing through the openings 35 in the bottom surface portion 39 of the support member 30, as shown in FIG. 7. In a second, extended position, the fingers 45, or a portion thereof, may extend a distance from the support member 30, as shown in FIG. 8. The support member 30 may be formed of materials such as plastics, polymers, bendable metals or composite materials that facilitate a rigid body. Manufacture of the support member 30 may include casting, extruding, cutting, turning, drilling, knurling, injection molding, spraying, blow molding, component overmolding, combinations thereof, or other fabrication methods that may provide efficient production of the component.

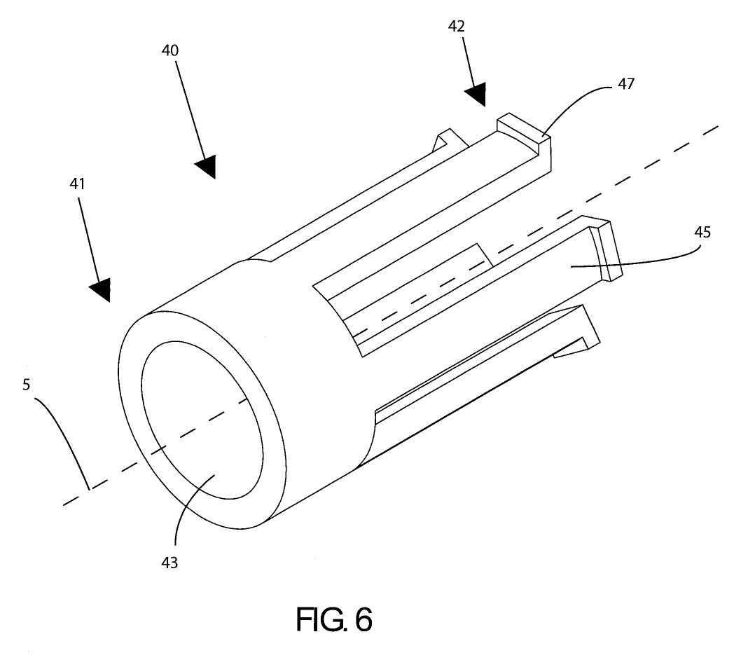

Referring to FIGS. 6-8, embodiments of seal trimmer 100 may also include a length guide portion 40 operably attached to the support member 30 to assist in determining an amount of the seal 80 that needs to be trimmed. The length guide portion 40 may be an adjustable length guide/structure/member configured to be variably disposed within the support member 30. The adjustable length guide portion 40 may include a first end 41, a second end 42, an inner surface 43, and an outer surface 44, and may be a generally annular member having a generally axial opening therethrough. Furthermore, embodiments of the length guide portion 40 may comprise a body portion 46 and one or more fingers 45 configured to extend into the cavity 37 of the support member 30 through the openings 35 in the bottom surface portion 39 of the support member 30, as shown in FIGS. 7A and 7B. The body portion may be an annular member configured to engage the base portion 25 of the port 20, and/or to be gripped by an installer for determining the required length of a seal 80. The one or more fingers 45 may be structurally integral with the body portion 46, and may extend substantially axially from the body portion 46; each finger may be separated by a gap or opening. The fingers 45 may provide some resiliency to the length guide portion 45 in the radial direction; the resiliency may allow for interchangeability of length guide portions 40 of different lengths. Because the length guide portion 40 is generally annular, the individual finger(s) may have a cross-section that is curvilinear, C-shaped, arcuate, and the like. The length guide portion 40 may be formed of materials such as plastics, polymers, bendable metals or composite materials that facilitate a rigid body. Manufacture of the length guide portion 40 may include casting, extruding, cutting, turning, drilling, knurling, injection molding, spraying, blow molding, component overmolding, combinations thereof, or other fabrication methods that may provide efficient production of the component.

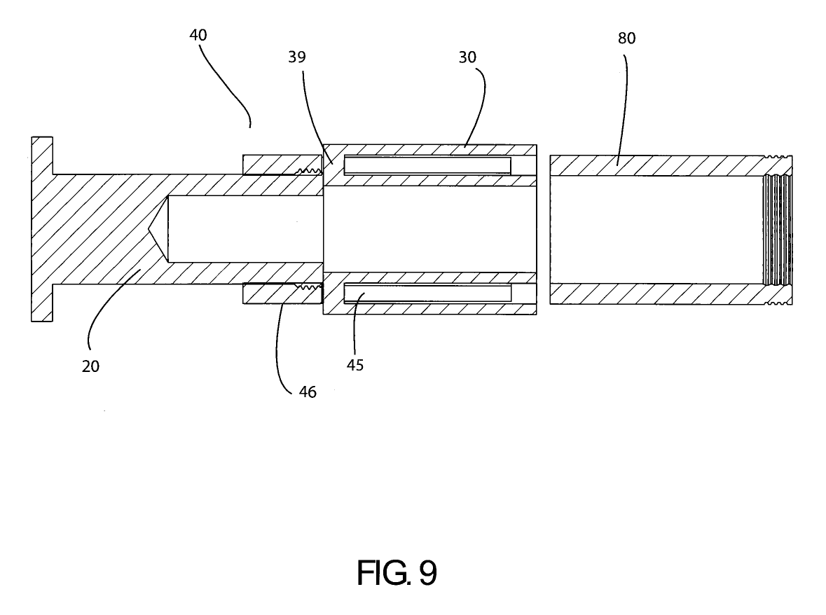

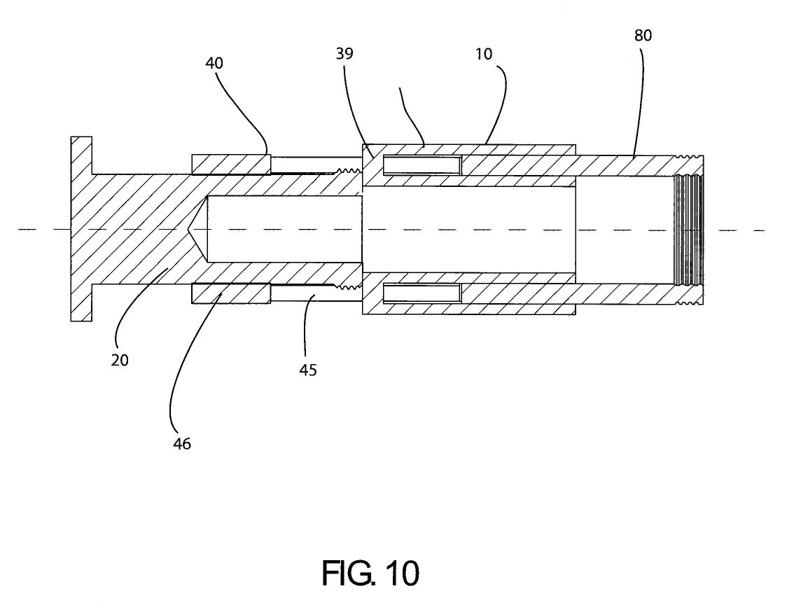

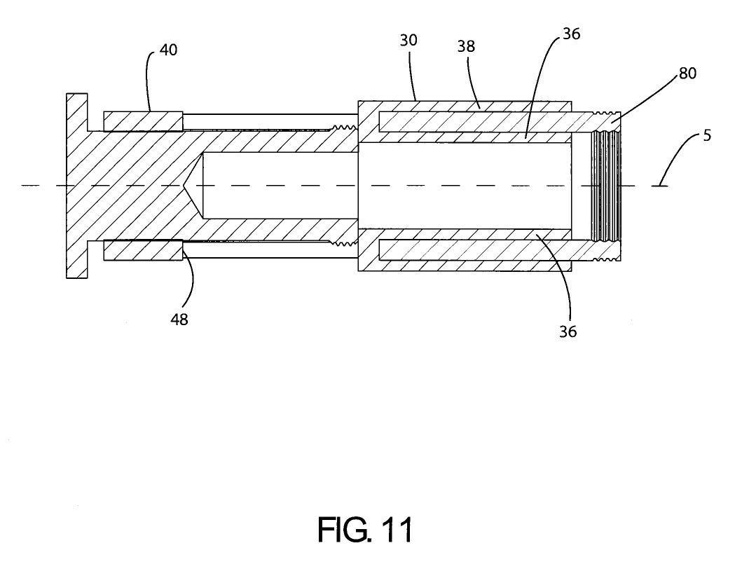

With continued reference to FIGS. 6-8, and additional reference to FIGS. 9-11, embodiments of the one or more fingers 45 connected to the body portion 46 may be displaced from the cavity 37 of the support member 30 by the seal 80 as the seal 80 is inserted into the support member 30, driving the body portion 46 of the length guide portion 40 into the base portion 25 of the port. FIG. 9 depicts an embodiment of a first, closed position, wherein the finger(s) resides within the cavity 37 of the support member 30 prior to insertion of the seal 80. FIG. 10 depicts an embodiment of a position between the closed and extended position, wherein the seal 80 has been inserted into the support member 30 to axially displace the length guide portion 40, in particular, the fingers 45, from the cavity 37 through the openings 35 towards the base portion 25 of the port 20. FIG. 11 depicts an embodiment of the second, extended position, wherein the inserted seal 80 has axially displaced the length guide portion 40 to the base portion 25 of the port 20 to determine the proper size of the seal 80. Thus, the length guide portion 40 may extend from the support member 30 the length of the port 20; the portion 83 of the seal 80 that remains exposed beyond the second end 32 of the support member 30 after the length guide portion 40 engages the base portion 25 of the port 20 can be trimmed by a installer's blade or an integral cutting means 90. For instance, the distance the length guide portion 40 displaces may equal the required size of the seal 80, and the excess portion 83 may be trimmed. Alternatively, an installer may place the seal trimmer 100 onto an end of the port 20, and advance the length guide portion 40 (e.g. by gripping the body portion 46) to a depth appropriate for the desired seal length and then place the seal trimmer 100 onto the seal 80 for cutting.

Embodiments of the length guide portion 40 may not include a body portion 46 and simply comprise one or more fingers 45 that may independently be displaced by from the cavity 37 to the base portion 25 of the port 20 as the seal 80 is inserted into the support member 30. For example, the length guide portion 20 may comprise a single axial member, such as a C-shaped peg, that may extend from the support member 30 through an opening 35 to the base portion 25 of the port 20 to determine the proper length of the seal.

Furthermore, embodiments of the length guide portion 40 may include a structural feature 47 that can prevent the length guide portion 40 from extending completely through the openings 35 in a direction towards the first end 31 of the support member 30 and disconnecting from the support member 30. For example, the fingers 45 may include a structural feature 47 at an end of the finger 45 to engage with the bottom surface portion 39 of the support member 30 to prevent unwanted disengagement from the support member 30. The structural feature 47 may be a lip, protrusion, or other suitable surface feature that may engage with the bottom surface portion 39 of the support member 30. For example, the area of the openings 35 may be slightly smaller than the area of a cross-section of the cavity 37 to facilitate engagement with the structural feature 47, such as lip to further prevent excessive displacement of the length guide portion 40. Further embodiments of the support member 30 may include a bottom surface portion 39 that has a surface feature to correspondingly engage the structural feature 47 of the length guide portion 40. Moreover, the thickness, girth, or overall size of the fingers 45 of the length guide portion 40 may correspond to the thickness or overall size of the cavity 37. In one embodiment, the size of the fingers 45 may establish an interference fit between the inner sleeve portion 36 and the outer sleeve portion 38 to avoid unwanted movement or displacement of the length guide portion 40 (i.e. movement/displacement not caused by the seal 80). For instance, the mechanical interference between the fingers 45 of the length guide portion 40 and the inner and outer sleeve portions 36. 38 should allow axial movement of the fingers 45 back and forth in the cavity 37 when subjected to an external force, such as the force exerted by the seal 80 when an installer inserts the seal 80 into the support member 30, but prevent or substantially hinder axial movement when no external force is applied.

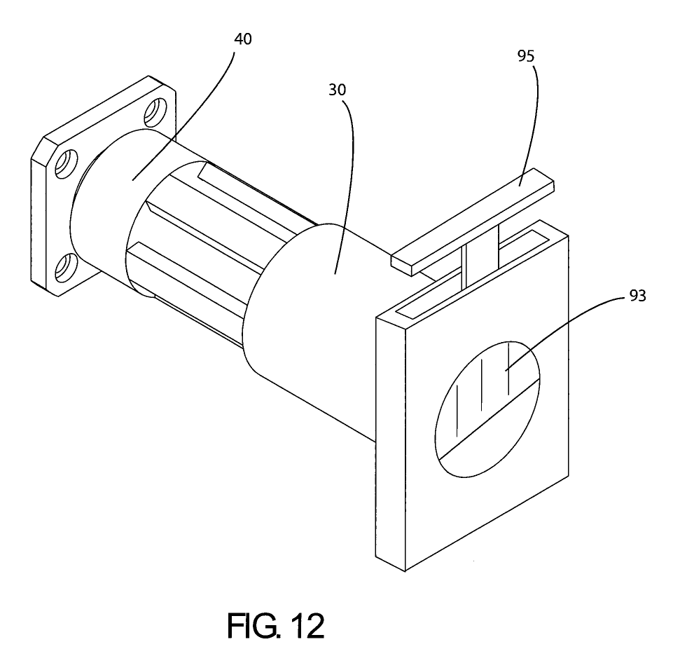

With reference now to FIG. 12, embodiments of the seal trimmer 100 may include a cutting means 90. The cutting means 90 may be operably attached to the support member 30 proximate or otherwise near the second end 32. Embodiments of the cutting means 90 may be integral with the support member 30, forming a one piece component. The cutting means 90 may incorporate a scissors, cigar-style trimmer, guillotine-like blade action, or other cutting mechanism, integrally disposed proximate the second end 32 of the support member 30 to cut off/trim the exposed portion 83 of the seal 80. Embodiments of a the cutting means 90 may be an integral cutting means having a blade 93 operably connected to an actuator 95, wherein actuation (i.e. pushing, sliding, squeezing, etc.) operates the blade 93 in a manner which may slice through the seal 80 along the outer sleeve portion 38 of the support member 30. The blade 93 may be integrally positioned at the second end 32 of the support member, adjacent to the outer sleeve portion 38. Those skilled in the art should appreciate that various cutting means and cutting motions may be incorporated to trim the exposed portion 83 of the seal 80 proximate or at the edge of the outer sleeve portion 38. Alternatively, the seal trimmer 100 may be removably attached or secured to a standard cutting device.

Referring now to FIGS. 1-12, embodiments of a method of determining a desired length of a port seal 80 may include the steps of providing an annular member 30 having an inner sleeve portion 36 and an outer sleeve portion 38 defining a cavity 37 therebetween, and a length guide portion 40 variably disposed within the cavity 37 of the annular member 30, advancing the length guide portion 40 towards a base portion 25 of a port 20 to vacate a portion of the cavity 27 and inserting the port seal 80 into the vacated cavity 37 of the annular member 30. Another method of determining a desired length of a port seal 80 may include the steps of providing a support member 30 having an inner sleeve portion 36 and an outer sleeve portion 38 defining a cavity 37 therebetween, and a length guide portion 40 variably disposed within the cavity 37 of the support member 30, inserting the seal 80 into a second end 32 of the support member 30 to axially displace the length guide portion 40 from the cavity 37, and trimming an exposed portion 83 of the seal 80 beyond the second end 32 of the support member 30.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A seal trimmer comprising:
a support member having a first portion and a second portion defining a cavity therebetween; and
a length guide portion variably disposed within the cavity of the support member.

2. The seal trimmer of claim 1, wherein the first portion and the second portion are structurally connected to a bottom surface portion.

3. The seal trimmer of claim 1, wherein the cavity is configured to accept a port seal, the port seal axially displacing the length guide portion from the support member.

4. The seal trimmer of claim 1, wherein the length guide portion includes a body portion and at least one finger extending from the body portion.

5. The seal trimmer of claim 1, further comprising:
a cutting means integral with the support member, the cutting means disposed proximate an end of the support member.

6. The seal trimmer of claim 1, wherein the support member includes a plurality of openings.

7. The seal trimmer of claim 1, wherein the first portion and the second portions are shaped like a sleeve.

8. An apparatus comprising:
an inner sleeve portion insertable within a port seal for preventing deformation of the port seal under a force of a cutting blade;
an outer sleeve portion configured to radially surround the port seal;
a bottom surface portion connecting the outer sleeve portion to the inner sleeve portion, wherein the bottom surface portion includes a plurality of openings; and
a plurality of axial fingers configured to extend from the bottom surface portion through the plurality of openings;
wherein an extension of the plurality of axial fingers determines a length of a port seal.

9. The apparatus of claim 8, wherein the plurality of axial fingers include a structural feature at one end to prevent complete disengagement with the bottom surface portion.

10. The apparatus of claim 8, wherein the plurality of axial fingers are partially disposed between the inner sleeve portion and the outer sleeve portion.

11. The apparatus of claim 8, wherein the outer sleeve portion indicates a proximity of an end of the inner sleeve portion.

12. The apparatus of claim 8, further comprising:
a cutting means integral with the support member, the cutting means disposed proximate an end of the support member.

13. A seal trimmer comprising:
an annular member having an inner sleeve portion and an outer sleeve portion defining a cavity therebetween; and
a means for determining a desired length of a port seal.

14. A method of determining a desired length of a port seal, comprising:
providing an annular member having an inner sleeve portion and an outer sleeve portion defining a cavity therebetween; and a length guide portion variably disposed within the cavity of the annular member;
advancing the length guide portion towards a base portion of a port to vacate a portion of the cavity; and
inserting the port seal into the vacated cavity of the annular member.

15. The method of claim 14, further comprising:
trimming an exposed portion of the seal.

16. The method of claim 15, wherein an integral cutting means trims the exposed portion of the seal.

17. The method of claim 14, wherein the length guide portion includes a body portion and at least one finger extending from the body portion.

18. A method of determining a desired length of a port seal, comprising
providing a support member having an inner sleeve portion and an outer sleeve portion defining a cavity therebetween; and a length guide portion variably disposed within the cavity of the support member;
inserting the seal into a second end of the support member to axially displace the length guide portion from the cavity; and
trimming an exposed portion of the seal beyond the second end of the support member.

19. The method of claim 18, wherein the length guide portion includes a body portion and at least one finger integral with the body portion.

20. The method of claim 18, wherein an integral cutting means trims the exposed portion of the seal.
